(19) United States
(12) Patent Application Publication
(10) Pub. No.: US 2005/0259589 A1
(43) Pub. Date: Nov. 24, 2005

(54) Logical services loopback

(75) Inventors: Bernard Rozmovits, Londonderry, NH (US); Mahendra J. Kaycee, Londonderry, NH (US); Paul A. Frechette, Manchester, NH (US)

Correspondence Address: MAINE & ASMUS, 100 MAIN STREET, P O BOX 3445, NASHUA, NH, 03061-3445, US

(73) Assignee: Metrobility Optical Systems Inc., Merrimack, NH (US)

(21) Appl. No.: 10/852,377

(22) Filed: May 24, 2004

(51) Int. Cl. H04L 1/00

(52) U.S. Cl. 370/249

(57) ABSTRACT

A logical services loopback framework for establishing transparent loopback connections and associations across Layer-2 networks is provided. The loopback framework operates as a termination/processing point for Transport, Connectivity and Services OAM flows. As a termination/processing point, the disclosed loopback framework realizes connections and associations that are used to transparently test and monitor various layers, such as OSI-specified protocol layers, policy-enabled layers, and/or business-oriented layers.

### FIELD OF THE INVENTION

The invention relates to network systems, and more particularly, to logical services loopback.

### BACKGROUND OF THE INVENTION

Optimal and profitable use of Ethernet remains a consistent goal of both service providers and their customers because of Ethernet's distinct advantages, such as CAP-EX and OP-EX. It is plug-and-play, readily extended and managed, and can be deployed cost-effectively. In addition, Ethernet is ubiquitous and used in numerous applications, including the metro access market. In particular, more than 90% of all data traffic in enterprise LANs begin and end on an Ethernet port. There are numerous other advantages and reasons that Ethernet technology is garnering so much attention in the metro access market.

From a business perspective, both carriers and subscribers gain from the deployment of Ethernet in service provider networks. Subscribers and other users get better, more cost-effective service, while network operators and carriers enjoy new sources of revenue, lower equipment costs, reduced operational expenditures, a streamlined provisioning process, shorter deployment and maintenance cycles, and increased margins. From a technology perspective, Ethernet offers greater bandwidth, incremental scaling, simpler provisioning, end-to-end LAN/WAN data transfers (e.g., IP over Ethernet) with no protocol conversion and a single standard for copper and fiber topologies.

The driving force behind a carrier-class Ethernet service is readily found in the applications that users are demanding. These revenue-generating applications go beyond simple high-speed Internet access to include features such as instant messaging, peer-to-peer networking, music downloads, video-on-demand, voice over IP, storage area networking, distance learning, video conferencing, among a variety of other emerging uses.

Another key demand driver is coming from service providers seeking to differentiate their offerings in a highly competitive market segment and to generate new sources of revenue. Typical operator service offerings that interconnect users and applications include, for example, LAN Interconnect, Virtual Private Line, Emulated Leased Line, Ethernet Internet Access, IP-VPN Access, and Ethernet Long Distance. For service providers to deliver such applications and operator services profitably, they must be consolidated over a single medium and effectively managed to offer performance guarantees to the subscriber and support measurable and enforceable service level agreements (SLAs).

Providing carrier-level quality of service (QoS) requires sophisticated monitoring and testing functions, as well as support for high-availability networking features to meet the requirements of demanding SLAs. Management of Ethernet-based services must map into current workflow paradigms of their carrier-based services counterparts, and must be cost-effective.

To that end, a conventional loopback service verifies that a remote node is receiving test packets sent by the transmitting node. This verification is carried out by receiving a test packet at the remote node, swapping the destination and source address of the packet, and sending it back to the transmitting node. Intermediate nodes can be specified to forward one or both of the outbound or incoming transmissions. QoS data can then be derived based the loopback results.

However, there are various limitations and problems associated with such conventional loopback techniques. For example, routers and other intelligent switches become confused when a single source address appears to be assigned to more than one node. Such confusion is the result of the address swapping performed at the target loopback node. As such, an intermediate switch will be unable to resolve its table of destination addresses versus ports. Thus, such solutions fail to map into current workflow paradigms. In addition, they tend to be costly.

What is needed, therefore, are improved loopback techniques that enable service providers to ensure SLAs and QoS and maintain high-availability networks, particularly across Layer-2 networks. In a more general sense, there is a need for transparent loopback techniques for transparently testing and monitoring associations of various network layers. The provided solutions should map into current workflow paradigms and be cost-effective.

### SUMMARY OF THE INVENTION

One embodiment of the present invention provides a method for performing logical services loopback at a station on a network. The method includes receiving an incoming Ethernet frame containing a source address and a destination loopback MAC address. The method proceeds with extracting the source address from the received frame, and generating a new frame by inserting the source address into the destination loopback MAC address location of the received frame. The method continues with inserting a loopback MAC address associated with the station into the source address location of the new frame, and looping back the new frame.

The method may further include calculating and appending an FCS to the new frame prior to the looping back. In one particular embodiment, receiving the incoming Ethernet frame includes the preliminary step of detecting the incoming Ethernet frame based on the destination loopback MAC address. Here, detecting the incoming Ethernet frame can be carried out, for example, by a Layer-2 Ethernet switch that is programmed to recognize one of more destination loopback MAC addresses, and the destination loopback MAC address is a MAC multicast address. Note that looping back the new frame can be carried out by providing the frame back to a Layer-2 Ethernet switch that detected the incoming Ethernet frame, and that is configured to forward the new frame using established forwarding rules.

The method may further include determining at least one of: one-way delay on a per-Entity basis, two-way delay on a per-Entity basis, variation in frame delay on a per-Entity basis, and traffic loss on a per-Entity, based on the loopback. Note that the loopback can be transparently performed in-service and at line speed. The method may further include localizing errors and network problems on a per-Entity basis by using loopback frames, with each loopback frame having a different multicast address as its destination loopback MAC address.

Another embodiment of the present invention provides a system for performing logical services loopback at a station on a network. The system includes an Ethernet frame receiver configured to receive an incoming Ethernet frame containing a source address and a destination loopback MAC address, and to extract the source address from the received frame. In addition, an Ethernet frame transmitter is configured to generate a new frame by inserting the source address into the destination loopback MAC address location of the received frame, and to insert a loopback MAC address associated with the station into the source address location of the new the new frame.

In one such embodiment, the Ethernet frame receiver further includes a CRC checker adapted to perform an error check on the received frame, and the Ethernet frame transmitter further includes a CRC generator adapted to calculate a frame check sequence for the new frame. In another such embodiment, the system may further include a Layer-2 Ethernet switch configured to detect the incoming Ethernet frame based on the destination loopback MAC address, and to forward that frame to the Ethernet frame receiver. Here, the Layer-2 Ethernet switch is further configured to forward the new frame using established forwarding rules.

The system may further include a frame FIFO configured to store frames and corresponding source addresses processed by the Ethernet frame receiver. In one such embodiment, the Ethernet frame transmitter is further configured to retrieve each frame and corresponding source address stored in the FIFO to generate the new frame. The system enables, for example, determining at least one of: one-way delay on a per-Entity basis, two-way delay on a per-Entity basis, variation in frame delay on a per-Entity basis, and traffic loss on a per-Entity, based on the loopback. The system may also enable localizing errors and network problems on a per-Entity basis by using loopback frames, with each loopback frame having a different multicast address as its destination loopback MAC address.

Note that the loopback can be transparently performed in-service and at line speed. The system may further include a processor configured to provide the station loopback MAC address. Such a local processor may further be used to provide both local and remote management functions, as well as other control parameters associated with the loopback process. In one particular embodiment, the system is implemented with programmable logic. One or more processors may also be included, that work in conjunction with the programmable logic, to effect an overall transparent logical services loopback scheme.

Another embodiment of the present invention provides a method for performing logical services loopback at a station on a network. The method includes receiving an incoming data frame containing a source address and a destination loopback physical address. The method continues with extracting the source address from the received frame, and generating a new frame by inserting the source address into the destination loopback physical address location of the received frame. The method continues with inserting a loopback physical address associated with the station into the source address location of the new frame, thereby providing a loopback frame that allows network-based physical address learning to continue without causing misdirected traffic. Various network layers can thus be tested and monitored, such as OSI-specified protocol layers, policy-enabled layers, and/or business-oriented layers.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a diagram illustrating a structured environment for the logical services loopback framework in accordance with one embodiment of the present invention.

FIG. 2a is a block diagram illustrating a system configured to perform logical services loopback in accordance with one embodiment of the present invention.

FIG. 2b illustrates the structure of incoming and outgoing loopback frames configured in accordance with one embodiment of the present invention.

FIG. 3 is a block diagram illustrating a logical services loopback module configured in accordance with one embodiment of the present invention.

FIG. 4 illustrates a method for performing logical services loopback in accordance with one embodiment of the present invention.

### DETAILED DESCRIPTION OF THE INVENTION

Embodiments of the present invention provide a framework for establishing transparent loopback connections and associations across Layer-2 networks. The connections and associations are used to transparently test and monitor various layers, such as OSI-specified protocol layers, policy-enabled layers, and/or business-oriented layers (e.g., service level agreements).

Structured Environment

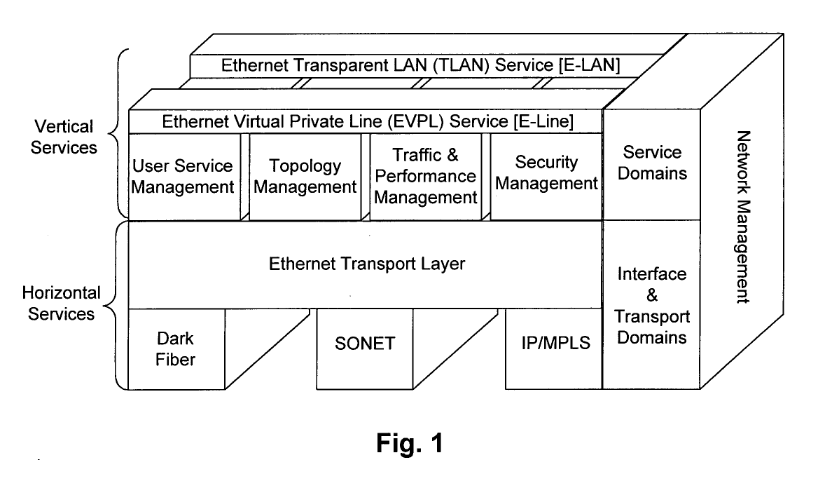

FIG. 1 is a diagram illustrating a structured environment for the logical services loopback framework in accordance with one embodiment of the present invention. Generally, every network is partitioned into management, or administrative, domains. A management domain—henceforth called Operations and Maintenance (OAM) domain—is defined either by a topology, a protocol boundary, or operational scope of an application protocol. OAM information is exchanged within each such domain, allowing each domain to be independently managed.

Entities, such as devices, protocol elements, and/or applications, within an OAM domain process OAM frames belonging to specific OAM flows (frames), by either terminating/peering or forwarding such flows. Entities that are defined by policies to be domain boundary elements for a particular OAM domain do not forward such OAM flows outside of that domain. OAM domains can either be concatenated, nested, or discontiguous.

First, as shown in FIG. 1, SONET-specific OAM operates only within a SONET network, while IP/MPLS OAM would operate only with an IP/MPLS network. An OAM function (e.g., frame loss) can operate across these two dissimilar networks by concatenating the two specific OAM flows at a common boundary Entity residing on both networks.

Second, OAM domains can be nested, by providing abstract common functions. For example, technology-specific OAM would operate independently in the SONET and IP/MPLS domains. A common Ethernet Transport Layer OAM function would be used to span dissimilar management domains.

Third, OAM domains can be discontiguous, in that a domain might be interconnected and separated by different domains. For example, consider the case where a provider's networks are interconnected by a transit, long distance provider. In such a case, OAM traffic is tunneled across the transit provider's network.

OAM domains fall into the following broad categories: Transport OAM, Connectivity OAM, and Services OAM. Transport OAM deals with technology-specific, transport Entities such as Ethernet, SONET, IP/MPLS, etc, and provides functions in support of logical services loopback. The containment scope is link-local or interface-local. Connectivity OAM deals with network connectivity with respect to Entities related to topology maintenance, path control, and traffic forwarding equivalence classes, and provides functions in support of logical services loopback. The containment scope is network-wide. Services OAM deals with application-level Entities and their usage, and provides functions in support of logical services loopback. The containment scope is service-aware.

The loopback framework described herein operates as a termination/processing point for each of Transport, Connectivity and Services OAM flows. The termination/processing point is generally referred to herein as a station that can exist anywhere on a network. Transparent, in-line loopback between any two stations or points on the network can be initiated at either of the stations, or at some remote station or management entity.

Logical Services Loopback

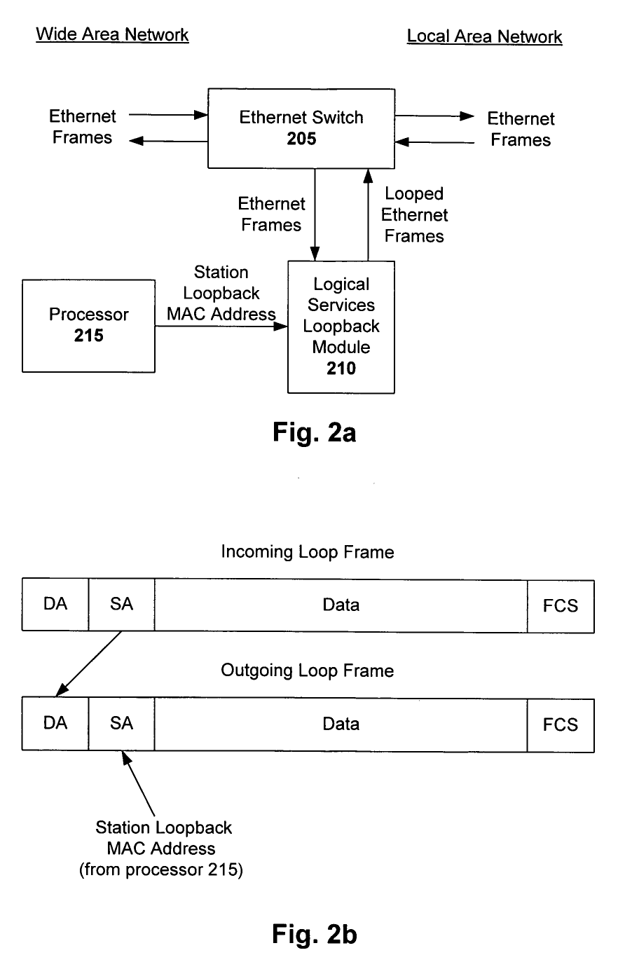

FIG. 2a is a block diagram illustrating a system configured to perform logical services loopback in accordance with one embodiment of the present invention. As can be seen, the system includes a conventional Ethernet switch 205, a logical services loopback module 210, and a processor 215. The system can be implemented, for example, at a switching node of a customer's site, where a wide area network (e.g., Internet) is coupled to the customer's local area network (as shown in FIG. 2a). Alternatively, the system can be implemented at any location in a metro area network. Generally stated, the system can be implemented at any station on a network. Numerous applications will be apparent in light of this disclosure.

In operation, multiple loopback addresses are provisioned (e.g., via software), thereby forming static address entries in the switch 205. In one embodiment, switch 205 is a 10/100 Mbps Ethernet switch. Frames matching these static entry addresses are identified by the switch 205, and forwarded to the logical services loopback module 210. The logical services loopback module 210 can be implemented, for example, with programmable logic (FPGA) or a purpose-built integrated circuit (ASIC). Alternatively, module 210 can be implemented using a microcontroller configured with a microprocessor, I/O ports, memory, and a number of processes for carrying out the loopback functionality as described herein. In one particular embodiment, the logical services loopback module 210 is a Spartan II FPGA configured to provide loopback functionality as described herein.

In any case, the logical services loopback module 210 is configured to use the station loopback MAC address as the source address in looped frames. In more detail, the logical services loopback module 210 receives incoming Ethernet frames provided by the switch 205 (e.g., based on destination loopback MAC addresses included in incoming Ethernet frames to be looped back), extracts the source address from each frame, and generates a new frame by inserting the source address into the destination address location. The station loopback MAC address is then inserted in the source address location of the new frame. The data portion of the new frame remains unchanged (as compared to the original incoming frame), and a frame check sequence (FCS) is calculated and appended to the end of the new frame. The new frame is then provided back to the switch 205 for loopback. Note that logical services loopback as described herein will work at full line rate and with any size frame.

FIG. 2b illustrates an example incoming frame and an outgoing frame. As can be seen, the source address (SA) of the incoming frame is used as the destination address (DA) of the outgoing frame. The station loopback MAC address is used as the source address of the outgoing frame. Thus, no intermediate switches in the loopback path will see the source address of the incoming frame as being associated with multiple nodes. Rather, such intermediate switches will see the station loopback MAC address, which is provided by the processor 215 or otherwise configured into the logical services loopback module 210.

In one particular embodiment, processor 215 is implemented with a Zilog eZ80F91 microcontroller, which can be programmed locally or remotely. Note that processor 215 is shown as separate from the logical loopback services module 210 for purposes of illustration. However, it will be apparent in light of this disclosure that the processor 215 can alternatively be integrated into the logical loopback services module 210, such as in the case where module 210 is implemented as a microcontroller. Further note that the processor 215 can be programmed to carry out application specific functionality.

The system can be configured to operate under software control, and enables transparent loopback functionality. Loopback can be initiated with a loopback request sent to the system from elsewhere on the network (either local or remote requests can be used). Service providers and network operators are able to test and monitor various layers, such as OSI-specified protocol layers, policy-enabled layers, and/or business-oriented layers (e.g., service level agreements). The system functions as the processing point for OAM flows (frames). It operates within the data path, at existing line speeds, and provides in-service and/or non-disruptive operation. In addition, it is transparent to Ethernet (unswitched and switched) networks, including IEEE 802.1Q Virtual LANs. The system also operates within IEEE 802.1D/Q bridging rules by not misdirecting MAC address learning.

Logical Services Loopback Architecture

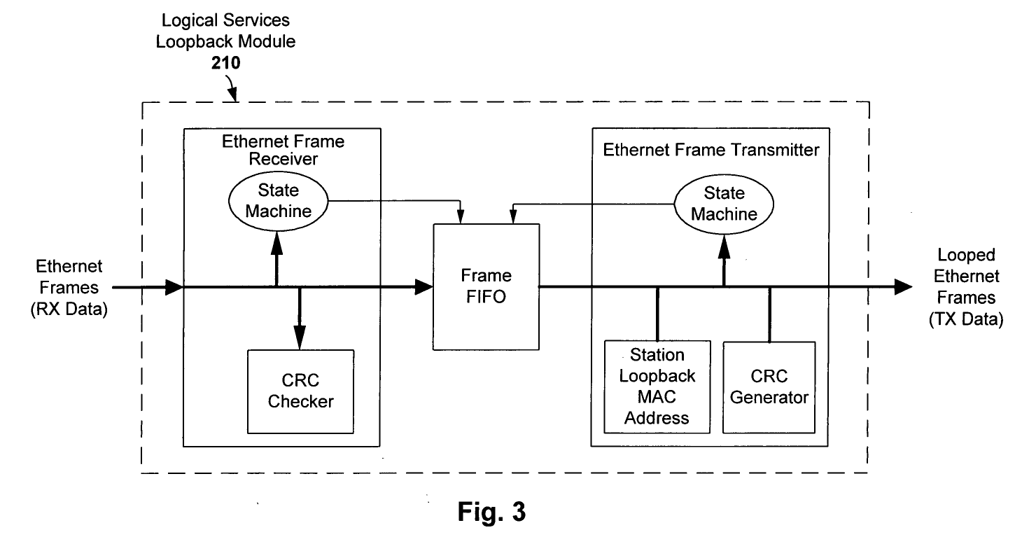

FIG. 3 is a block diagram illustrating a logical services loopback module 210 configured in accordance with one embodiment of the present invention. As previously explained, the module 210 can be implemented as an FPGA, ASIC, or microcontroller. Other implementations and configurations will be apparent in light of this disclosure. The module works in conjunction, for instance, with conventional off-the-shelf or customized Layer-2 Ethernet switching silicon, as well as other standards-based MAC/physical layer switching hardware.

As previously discussed, a Layer-2 Ethernet switch is programmed to recognize one of more MAC addresses that reside in various target areas, and which indicate a frame as being a frame intended for loopback. These addresses may either be MAC unicast or multicast addresses, and are referred to herein as destination loopback MAC addresses. During normal system operation, Ethernet frames addressed to any of the destination loopback MAC addresses are directed by the Ethernet switch to the logical services loopback module 210.

As can be seen in FIG. 3, the module 210 includes an Ethernet frame receiver portion and an Ethernet frame transmitter portion. The Layer-2 switching detects Ethernet frames including a destination loopback MAC address, and forwards those frames to the Ethernet frame receiver. A state machine or other processor of the receiver portion of module 210 is configured/programmed to receive an incoming frame, and to extract the source address therein. A cyclic redundancy check (CRC) may also be carried out, to ensure the integrity of the incoming frame. The processed frames and their corresponding source addresses are then provided to a FIFO queue or other storage facility to await further processing by the transmitter portion of module 210.

The state machine or other processor of the transmitter is configured to retrieve each stored frame and its extracted source address, and to insert that source address into the destination address location of that frame, thereby effectively generating a new frame for loopback. Note that the data portions of the frame remain unchanged by the logical services loopback process. The state machine then retrieves the station loopback MAC address and inserts that MAC address into the source address location of the new frame. In the embodiment shown in FIG. 3, the station loopback MAC address is retrieved from a station loopback MAC address memory module. This memory location can be stocked, for example, by processor 215.

In one particular embodiment, the station loopback MAC address is a unicast MAC address. Note that the stored station loopback MAC address can be programmed by operation of local or remote commands and/or downloads to the local processor (e.g., processor 215). In using the station loopback MAC address (as opposed to promulgating the original source MAC address from the incoming OAM frame), network-based MAC address learning can continue to operate unmodified and uninterrupted, without causing misdirected traffic. In this sense, the logical services loopback performed is transparent and efficient.

A CRC generator may also be included that calculates a new FCS, which the state machine appends to the frame to be looped. The frame is then provided by the module 210 to the physical layer switch 205, which forwards the frame using conventional, standard forwarding rules.

Logical Services Loopback Features

Logical services loopback as described herein provides management and OAM for administrative domains. Numerous characteristics and benefits can thus be realized as will be apparent in light of this disclosure. For example, access control is enabled, which ensures that OAM flows (frames) are contained within a domain by intelligent address filtering. For instance, OAM flows (frames) are contained within a domain by administratively programming the Ethernet switching silicon of that particular station to discard frames of interest.

Application independence is also provided, in that the logical services loopback framework is independent of higher-layer management applications, by operating at the MAC or physical layer. Likewise, the logical services loopback framework is independent of the underlying transport layer by operating at the MAC or physical layer. The availability provided by the logical services loopback framework ensures that management applications are able to determine service availability on a per-Entity basis by, for example, using different destination MAC multicast addresses. Likewise, the connectivity provided by the logical services loopback framework ensures that management applications are able to communicate on a per-Entity basis, upon noting corresponding availability.

The logical services loopback framework also provides backward compatibility, in that OAM flows (frames) handling is defined and processed at the MAC layer, thereby interworking with existing Layer-2 Ethernet equipment. Thus, no changes to existing Layer-2 Ethernet equipment is required. Looking forward, further note that the logical services loopback framework can also be transparently extended to support newer, future capabilities by, for example, directing frames of interest to the processor 215 that has software control over the logical services loopback module 210. Data plane usage ensures that OAM flows (frames) are forwarded along a path similar to data frames by, for example, using existing MAC forwarding rules.

Logical services loopback as described herein further allows for domain discovery and Entity discovery. In particular, management applications are able to discover the scope or “edges” of an OAM domain with, for example, the Ethernet switching silicon discarding frames of interest by prior agreement. Also, management applications are able to discover MAC address corresponding service Entities (thereby allowing OAM messages to be exchanged) by, for example, observing the station loopback MAC addresses.

Various test measurements are also enabled. For example, management applications are able to determine one-way and two-way delay on a per-Entity basis, as well as variation in frame delay on a per-Entity basis, with the OAM flow (frame) loopback being transparently performed in hardware (e.g., FPGA) or firmware (e.g., programmable microcontroller), and at line speed. Management applications are also able to determine traffic loss on a per-Entity basis with the OAM flow (frame) loopback being transparently performed in hardware or firmware, and it line speed. Such diagnostic testing and measurement flexibility allows for robust fault management, where errors and problems can be localized on a per-Entity basis by, for instance, using OAM flow (frame) loopback with different MAC multicast addresses as the respective destination loopback MAC addresses.

Methodology

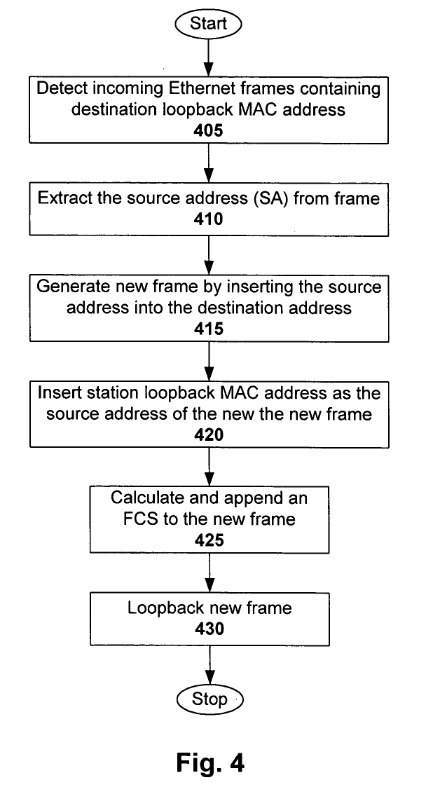

FIG. 4 illustrates a method for performing logical services loopback in accordance with one embodiment of the present invention. The method can be carried out, for example, by the system discussed in reference to FIG. 2. However, other implementations will be apparent in light of this disclosure, where the described functionality is carried out with hardware, software, firmware, or some combination thereof.

The method begins with detecting 405 incoming Ethernet frames containing a destination loopback MAC address. This step can be carried out, for example, by a conventional Layer-2 Ethernet switch that is programmed to recognize one of more destination loopback MAC addresses (MAC unicast or multicast). Here, the Ethernet frames addressed to any or selected ones of the destination loopback MAC addresses are separated from the data flow for further processing (on a per frame basis) as will now be described.

In particular, the method continues with extracting 410 the source address (SA) from a detected frame, and generating 415 a new frame by inserting the source address into the destination address location of that frame. The method continues with inserting 420 the station loopback MAC address as the source address of the new the new frame. As previously stated, using the station loopback MAC address (as opposed to the original source MAC address from the incoming OAM frame) allows network-based MAC address learning to continue without causing misdirected traffic.

The method may proceed with calculating and appending 425 an FCS to the new frame, and looping 430 back the new frame. This loopback can be carried out, for example, by providing the frame back to the Layer-2 Ethernet switch that detected the original frame in step 405. The switch then forwards the frame using established forwarding rules.

Implementation Details

In one particular embodiment, a 10/100 Mbps Ethernet switch detects (step 405) frames designated for loopback based on the destination loopback MAC address included in selected frames. One port of the switch can be, for example, a 10/100 copper Ethernet port, while the other port can be a 100 Mbps fiber port. Alternatively, both ports can be copper, or both can be fiber. Various port/speed schemes can be used here. This switch also loops back the new frames (step 430) resulting from the logical services loopback processing, using established forwarding rules.

The logical services loopback functionality of this example embodiment is implemented with a Spartan II FPGA configured to provide loopback functionality as described herein (steps 410, 415, 420, and 425). LEDs can be used to monitor status of the FPGA, and dip switches can be used to configure the FPGA for a particular application. A programmable memory, such as a serial EEPROM, can be used to store the unique station identifier (i.e., station loopback MAC address). This memory is accessible to the processor via an Inter-Integrated Circuit (I²C) bus, which allows the memory to be accessed via embedded software and remote management. The FPGA is also coupled to the processor by an 8 bit parallel bus, which allows reads and writes to specific registers of the FPGA.

The processor in this example embodiment is a Zilog eZ80F91 microcontroller, which can be used to provide local and remote programmability (e.g., to provide the station loopback MAC address to the Spartan II FPGA module, and to calculate timing and other diagnostic information associated with the received frames). The Ethernet MAC (EMAC) interface of the processor is connected to the in-band management port of the Ethernet switch. Note that the processor may further include other supporting functionality, such as memory (e.g., Flash for storing FPGA configuration information and RAM/ROM for storing application specific process instructions and destination Ethernet MAC addresses) and a universal asynchronous receiver-transmitter (UART) timer and general purpose I/O.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

1. A method for performing logical services loopback at a station on a network, the method comprising:
receiving an incoming Ethernet frame containing a source address and a destination loopback MAC address;
extracting the source address from the received frame;
generating a new frame by inserting the source address into the destination loopback MAC address location of the received frame;
inserting a loopback MAC address associated with the station into the source address location of the new frame; and
looping back the new frame.

2. The method of claim 1 further comprising: calculating and appending an FCS to the new frame prior to the looping back.

3. The method of claim 1 wherein receiving the incoming Ethernet frame includes the preliminary step of detecting the incoming Ethernet frame based on the destination loopback MAC address.

4. The method of claim 3 wherein detecting the incoming Ethernet frame is carried out by a Layer-2 Ethernet switch that is programmed to recognize one of more destination loopback MAC addresses, and the destination loopback MAC address is a MAC multicast address.

5. The method of claim 1 wherein looping back the new frame is carried out by providing the frame back to a Layer-2 Ethernet switch that detected the incoming Ethernet frame, and that is configured to forward the new frame using established forwarding rules.

6. The method of claim 1 further comprising: determining at least one of one-way delay on a per-Entity basis, two-way delay on a per-Entity basis, variation in frame delay on a per-Entity basis, and traffic loss on a per-Entity, based on the loopback.

7. The method of claim 1 further wherein the loopback is transparently performed in-service and at line speed.

8. The method of claim 1 further comprising: localizing errors and network problems on a per-Entity basis by using loopback frames, with each loopback frame having a different multicast address as its destination loopback MAC address.

9. A system for performing logical services loopback at a station on a network, the system comprising:
an Ethernet frame receiver configured to receive an incoming Ethernet frame containing a source address and a destination loopback MAC address, and to extract the source address from the received frame; and
an Ethernet frame transmitter configured to generate a new frame by inserting the source address into the destination loopback MAC address location of the received frame, and to insert a loopback MAC address associated with the station into the source address location of the new the new frame.

10. The system of claim 9 wherein the Ethernet frame receiver further includes a CRC checker adapted to perform an error check on the received frame, and the Ethernet frame transmitter further includes a CRC generator adapted to calculate a frame check sequence for the new frame.

11. The system of claim 9 further comprising a Layer-2 Ethernet switch configured to detect the incoming Ethernet frame based on the destination loopback MAC address, and to forward that frame to the Ethernet frame receiver.

12. The system of claim 11 wherein the Layer-2 Ethernet switch is further configured to forward the new frame using established forwarding rules.

13. The system of claim 9 further comprising a frame FIFO configured to store frames and corresponding source addresses processed by the Ethernet frame receiver.

14. The system of claim 13 wherein the Ethernet frame transmitter is further configured to retrieve each frame and corresponding source address stored in the FIFO to generate the new frame.

15. The system of claim 9 wherein the system enables determining at least one of one-way delay on a per-Entity basis, two-way delay on a per-Entity basis, variation in frame delay on a per-Entity basis, and traffic loss on a per-Entity, based on the loopback.

16. The system of claim 9 wherein the loopback is transparently performed in-service and at line speed.

17. The system of claim 9 wherein the system enables localizing errors and network problems on a per-Entity basis by using loopback frames, with each loopback frame having a different multicast address as its destination loopback MAC address.

18. The system of claim 9 further comprising a processor configured to provide the station loopback MAC address.

19. The system of claim 9 further wherein the system is implemented with programmable logic.

20. A method for performing logical services loopback at a station on a network, the method comprising:
receiving an incoming data frame containing a source address and a destination loopback physical address;
extracting the source address from the received frame;
generating a new frame by inserting the source address into the destination loopback physical address location of the received frame; and
inserting a loopback physical address associated with the station into the source address location of the new frame, thereby providing a loopback frame that allows network-based physical address learning to continue without causing misdirected traffic.
